(19) United States
(12) Patent Application Publication
(10) Pub. No.: US 2019/0155675 A1
(43) Pub. Date: May 23, 2019

(54) METHOD AND APPARATUS FOR DIAGNOSING A SYSTEM PERFORMANCE PROBLEM

(71) Applicant: JPMorgan Chase Bank, N.A., New York, NY (US)

(72) Inventors: Sarma V. Appala, Dublin, OH (US); Brian Donelan, Granville, OH (US)

(73) Assignee: JPMorgan Chase Bank, N.A., New York, NY (US)

(21) Appl. No.: 16/190,961

(22) Filed: Nov. 14, 2018

Related U.S. Application Data
(60) Provisional application No. 62/589,654, filed on Nov. 22, 2017.

(51) Int. Cl. G06F 11/07; G06F 11/34; H04W 24/08; H04W 76/10; H04L 12/26; H04L 12/24

(52) U.S. Cl. CPC G06F 11/079; G06F 11/3419; H04W 24/08; G06F 2201/875; H04L 43/0852; H04L 41/142; H04L 41/22; H04W 76/10

(57) ABSTRACT

Various methods, apparatuses, and media for diagnosing a system performance problem are provided. The methodology includes operations of establishing a communication link between a client device and a server device; measuring a data rate of the communication link; collecting data relating to each of the client device and the server device; using the measured data rate and the collected data to determine a source of a delay on the communication link; and diagnosing the system performance problem based on the determined source of the delay. Performance metrics may be determined from the collected data, and then correlated together in order to diagnose the problem.

### CROSS-REFERENCE TO RELATED APPLICATION

This application claims the benefit of U.S. Provisional Patent Application Ser. No. 62/589,654, filed Nov. 22, 2017, which is hereby incorporated by reference in its entirety.

### BACKGROUND

### 1. Field of the Disclosure

This technology generally relates to monitoring system performance, and, more particularly, to methods and apparatuses for diagnosing system performance problems that relate to communication delays.

### 2. Background Information

In the current technological environment, when client devices communicate with server devices over a network, an occurrence of a system performance problem may arise, thereby resulting in a communication delay. The system performance problem may include, for example, delayed server responses, slow webpage load times, network congestion, system latency, lack of resource availability, slow client device response times, and/or any other issue that causes a delay.

When a system performance problem occurs, it is important that the problem be identified and rectified. In particular, when a communication delay is observed, a determination as to the nature of the problem and the source of the delay is required in order to enable resolution of the problem.

### SUMMARY

The present disclosure, through one or more of its various aspects, embodiments, and/or specific features or sub-components, provides, inter alia, various systems, servers, devices, methods, media, programs, and platforms for diagnosing a system performance problem. The various aspects, embodiments, features, and/or sub-components provide optimized processes of diagnosing a system performance problem based on measuring data rates, monitoring client devices and server devices in order to determine performance metrics, and using the performance metrics to determine a source of a communication delay.

According to an aspect of the present disclosure, a method for diagnosing a system performance problem with respect to a system that includes at least one client device and at least one server device is provided. The method may be implemented by a performance measurement device. The method includes: receiving, from the at least one client device, a user request that relates to a service associated with the at least one server device; establishing a communication link betweeen the at least one client device and the at least one server device; measuring a data rate of the communication link; collecting first data that relates to the at least one client device; collecting second data that relates to the at least one server device; using the measured data rate, the collected first data, and the collected second data to determine a source of a delay with respect to the communication link; and diagnosing, based on the determined source of the delay, the system performance problem.

The method may further include displaying, on a display of the performance measurement device, a graphical representation of at least one from among the measured data rate, the collected first data, and the collected second data.

The method may further include displaying, on a display of the performance measurement device, a graphical representation of at least one from among the measured data rate, the collected first data, and the collected second data

The determining of the source of the delay may include determining, based on the measured data rate and the collected first data and second data, at least one client device performance metric and at least one server device performance metric.

The method may further include correlating each of the at least one client device performance metric with each of the at least one server device performance metric. The diagnosing of the system performance problem may be performed based on a result of the correlating.

The method may further include displaying, on a display of the performance measurement device, a user interface that includes information that relates to the diagnosed system performance problem.

The method may further include using the collected first data and the collected second data to determine a time point at which the system performance problem began.

The collected first data may include at least one from among data that relates to usage of a central processing unit of the at least one client device and data that relates to usage of a memory of the at least one client device.

The collected second data may include at least one from among data that relates to usage of a central processing unit of the at least one server device and data that relates to usage of a memory of the at least one server device

According to another aspect of the present disclosure, a performance measurement device configured to diagnose a system performance problem with respect to a system that includes at least one client device and at least one server device is provided. The performance measurement device includes a display, a communication interface, a memory, and a processor. The processor is configured to: receive, from the at least one client device via the communication interface, a user request that relates to a service associated with the at least one server device; establish a communication link betweeen the at least one client device and the at least one server device; measure a data rate of the communication link; collect first data that relates to the at least one client device; collect second data that relates to the at least one server device; use the measured data rate, the collected first data, and the collected second data to determine a source of a delay with respect to the communication link; and diagnose, based on the determined source of the delay, the system performance problem.

The processor may be further configured to cause the display to display a graphical representation of at least one from among the measured data rate, the collected first data, and the collected second data.

The processor may be further configured to use the measured data rate, the collected first data, and the collected second data to determine at least one client device performance metric and at least one server device performance metric.

The processor may be further configured to correlate each of the at least one client device performance metric with each of the at least one server device performance metric, and to diagnose the system performance problem based on a result of the correlation.

The processor may be further configured to cause the display to display a user interface that includes information that relates to the diagnosed system performance problem.

The processor may be further configured to use the collected first data and the collected second data to determine a time point at which the system performance problem began.

The collected first data may include at least one from among data that relates to usage of a central processing unit of the at least one client device and data that relates to usage of a memory of the at least one client device.

The collected second data may include at least one from among data that relates to usage of a central processing unit of the at least one server device and data that relates to usage of a memory of the at least one server device.

According to yet another aspect of the present disclosure, a non-transitory computer readable medium configured to store instructions for implementing a method for diagnosing, by a performance measurement device, a system performance problem with respect to a system that includes at least one client device and at least one server device is provided. When executed, the instuctions cause a computer to: receive, from the at least one client device, a user request that relates to a service associated with the at least one server device; establish a communication link betweeen the at least one client device and the at least one server device; measure a data rate of the communication link; collect first data that relates to the at least one client device; collect second data that relates to the at least one server device; use the measured data rate, the collected first data, and the collected second data to determine a source of a delay with respect to the communication link; and diagnose, based on the determined source of the delay, the system performance problem.

The instructions may further cause the computer to use the measured data rate, the collected first data, and the collected second data to determine at least one client device performance metric and at least one server device performance metric, to correlate each of the at least one client device performance metric with each of the at least one server device performance metric, and to diagnose the system performance problem based on a result of the correlation.

The instructions may further cause the computer to display, on a display of the performance measurement device, a user interface that includes information that relates to the diagnosed system performance problem.

The instructions may further cause the computer to use the collected first data and the collected second data to determine a time point at which the system performance problem began.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system for diagnosing a system performance problem.

FIG. 2 illustrates an exemplary diagram of a network environment with a performance measurement device.

FIG. 3 shows an exemplary system for diagnosing a system performance problem based on correlating client device metrics and server device metrics.

FIG. 4 is a flowchart of an exemplary process for diagnosing a system performance problem based on correlating client device metrics and server device metrics.

FIG. 5 is a screen shot of an exemplary user interface dashboard on which data relating to network performance metrics is displayed.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

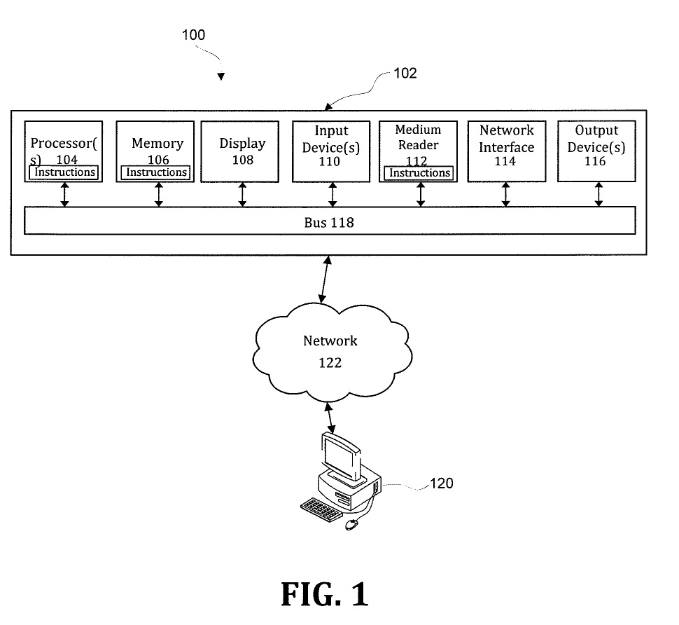

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a video display 108, such as a liquid crystal display (LCD), an organic light emitting diode (OLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized processes of selecting and recommending a transaction mode based on available user transaction modes and a location of a user.

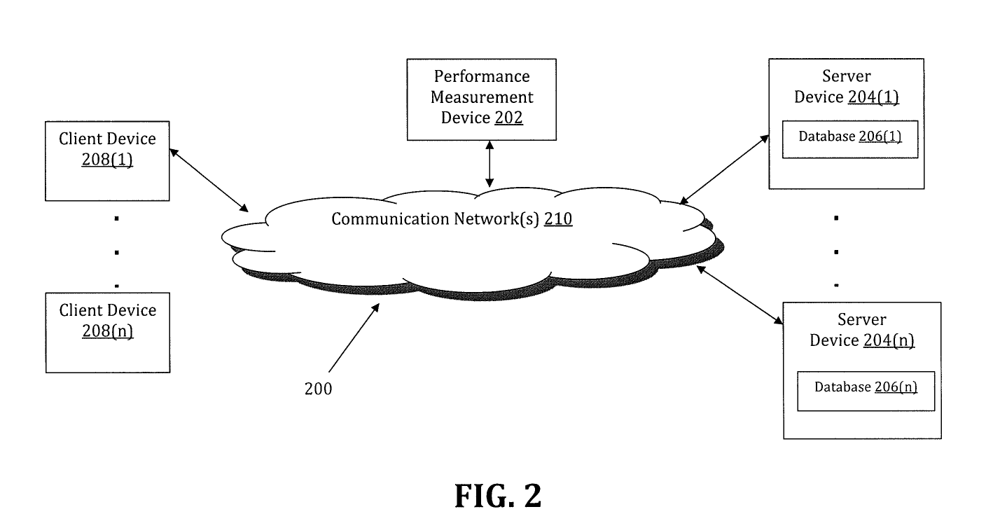

Referring to FIG. 2, a schematic of an exemplary network environment 200 for diagnosing a system performance problem based on correlating client device metrics and server device metrics is illustrated. The system performance problem may generally relate to a delay in a communication between a client device and a server device, and may include, for example, a delayed server response, a slow webpage load time, network congestion, system latency, lack of resource availability, a slow client device response time, and/or any other issue that causes a delay.

The diagnosis of a system performance problem may be facilitated by a Performance Measurement (PM) device 202. The PM device 202 may be the same or similar to the computer system 102 as described with respect to FIG. I. The PM device 202 may store one or more applications that can include executable instructions that, when executed by the PM device 202, cause the PM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PM device 202 itself, may be located in virtual server(s) running in a cloud-based computing environment rather than being tied to one or more specific physical network computing devices. Also, the application(s) may be running in one or more virtual machines (VMs) executing on the PM device 202. Additionally, in one or more embodiments of this technology, virtual machine(s) running on the PM device 202 may be managed or supervised by a hypervisor.

In the network environment 200 of FIG. 2, the PM device 202 is coupled to a plurality of server devices 204(1)-204(n) that hosts a plurality of databases 206(1)-206(n), and also to a plurality of client devices 208(1)-208(n) via communication network(s) 210. A communication interface of the PM device 202, such as the network interface 114 of the computer system 102 of FIG. 1, operatively couples and communicates between the PM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PM device 202, the server devices 204(1)-204(n), and/or the client devices 208(1)-208(n) may be coupled together via other topologies. Additionally, the network environment 10 may include other network devices such as one or more routers and/or switches, for example, which are well known in the art and thus will not be described herein. This technology provides a number of advantages including methods, non-transitory computer readable media, and PM devices that efficiently generate and manage metadata in order to automatically facilitate generate new data.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PM device 202 may be a standalone device or integrated with one or more other devices or apparatuses, such as one or more of the server devices 204(1)-204(n), for example. In one particular example, the PM device 202 may include or be hosted by one of the server devices 204(1)-204(n), and other arrangements are also possible. Moreover, one or more of the devices of the PM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can facilitate the generation of price quote requests, such as in response to user interaction with graphical user interfaces for example. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example.

The client devices 208(1)-208(n) may run interface applications, such as standard web browsers or standalone client applications, which may provide an interface to communicate with the PM device 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the PM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PM device 202, the server devices 204(1)-204(n), or the client devices 208(1)-208(n), for example, may be configured to operate as virtual instances on the same physical machine. In other words, one or more of the PM device 202, the server devices 204(1)-204(n), or the client devices 208(1)-208(n) may operate on the same physical device rather than as separate devices communicating through communication network(s) 210. Additionally, there may be more or fewer PM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks. Packet Data Networks (PDNs), the Internet, intranets, and combinations thereof.

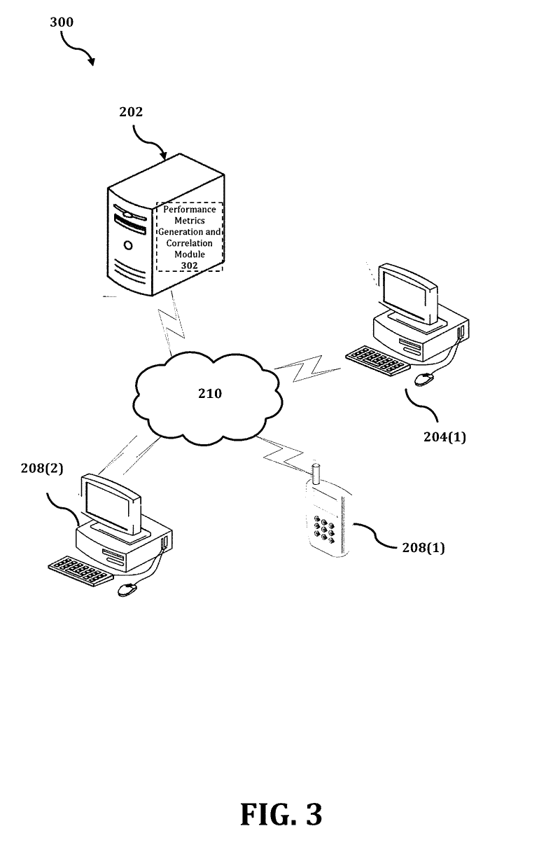

The PM device 202 is described and shown in FIG. 3 as including a performance metrics generation and correlation module 302, although it may include other rules, policies, modules, databases, or applications, for example. As will be described below, the performance metrics generation and correlation module 302 is configured to generate and correlate performance metrics. The performance metrics are generated based on measurements of communication data rates, data relating to the client devices 208(1)-208(n), and data relating to the server devices 204(1)-204(n). The performance metrics are then correlated in order to diagnose a system performance problem.

An exemplary process 300 for generating new data by utilizing the network environment of FIG. 2 is shown as being conducted in FIG. 3. Specifically, a first client device 208(1) and a second client device 208(2) are illustrated as being in communication with PM device 202. In this regard, the first client device 208(1) and the second client device 208(2) may be “clients” of the PM device 202 and are described herein as such. Nevertheless, it is to be known and understood that the first client device 208(1) and/or the second client device 208(2) need not necessarily be “clients” of the PM device 202, or any entity described in association therewith herein. Any additional or alternative relationship may exist between either or both of the first client device 208(1) and the second client device 208(2) and the PM device 202, or no relationship may exist.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the PM device 202 via broadband or cellular communication. Of course, these embodiments are merely exemplary and are not limiting or exhaustive.

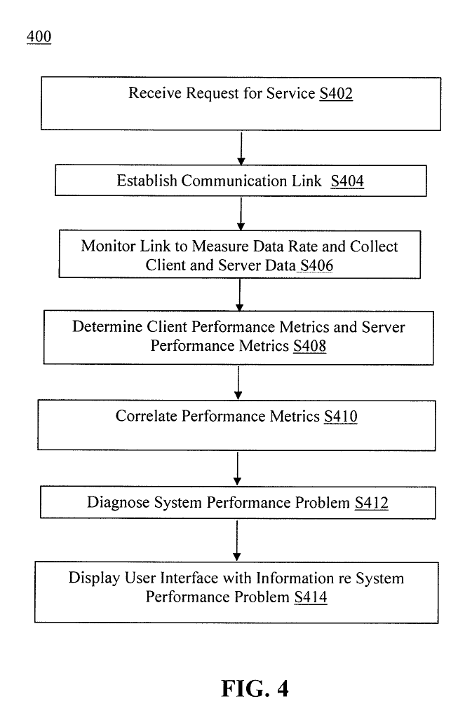

Upon being started, the performance metrics generation and correlation module 302 executes a process for diagnosing a system performance problem. An exemplary process for diagnosing a system performance problem is generally indicated at flowchart 400 in FIG. 4.

In the process 400 of FIG. 4, a user request for accessing a service is received from a client device 208 at step S402. The service may include, for example, a request for a web page, a business transaction request, or a payment processing request.

At step S404, the PM device 202 identifies at least one server device 204 that is suitable for providing the requested service, and then establishes a communication link between the client device 208 and the identified server device 204. As a result of the establishment of the communication link, data is communicated via the link.

At step S406, the PM device 202 monitors the link in order to measure the communication data rate and to collect data relating to the client device and the server device. The data relating to the client device may include, for example: real time user actions, such as user clicks and/or user scrolls while accessing mobile device applications and/or desktop computer browser applications; data that is captured by a camera of a mobile device; data that is captured by a gyroscope of a mobile device; geographical data that relates to location(s) of a mobile device; an amount of screen time for a particular web page; client device location information; memory utilization of the client device; processor utilization of the client device; a number of resources occupied by the client) device; a cellular service provider associated with the client device; and/or a client device response time. The client device response time may include, for example, an upload time for a web page associated with a business transaction and an amount of time required for the client device to respond to a server request. The data relating to the server device may include, for example: server error log data; memory utilization of the server device; processor utilization of the server device; a number of resources occupied by the server device; and/or a server response time. The server response time may include, for example, an amount of time required for responding to a user request for a web page.

At step S408, client performance metrics and server performance metrics are determined. In an exemplary embodiment, the performance metrics generation and correlation module 302 is configured to generate performance metrics. The client performance metrics are determined based on the data relating to the client device collected during the monitoring of the communication link in step S406. The server performance metrics are determined based on the data relating to the server device collected during the monitoring of the communication link in step S406.

At step S410, the performance metrics are correlated. In an exemplary embodiment, the performance metrics generation and correlation module 302 is configured to perform the correlation by indexing the collected data and the metrics in a database and then evaluating and analyzing the data by performing a predefined set of calculations and/or applying an algorithm that has been developed for a particular type of service.

At step S412, a system performance problem is diagnosed. In an exemplary embodiment, the performance metrics generation and correlation module 302 is configured to use a result of the correlation to identify a source of a delay and/or a time point at which a delay began, and to determine a problem that is associated therewith. The system performance problem may include at least one of the following types of problems: a bottleneck problem associated with a client-server link; an end-to-end performance efficiency problem; a server overload problem that relates to a number of services being provided and/or a repetition of a same service being performed multiple times; a delay associated with loading or rendering a web page at a client device; and a delay associated with a particular service.

For example, the PM device 202 may determine that a system response time delay of 25 milliseconds has occurred. Based on the collected data and the correlation process, a determination may be made that the delay has been caused by a 15-millisecond delay associated with loading a web page at a client device and a 10-millisecond delay associated with the particular service being provided by the server device. In this aspect, by identifying the cause(s) and/or source(s) of a delay, a type of problem may be diagnosed, and remedial measures may be indicated, such as, for example, identifying a relevant software routine that may be updated in order to eliminate the delay.

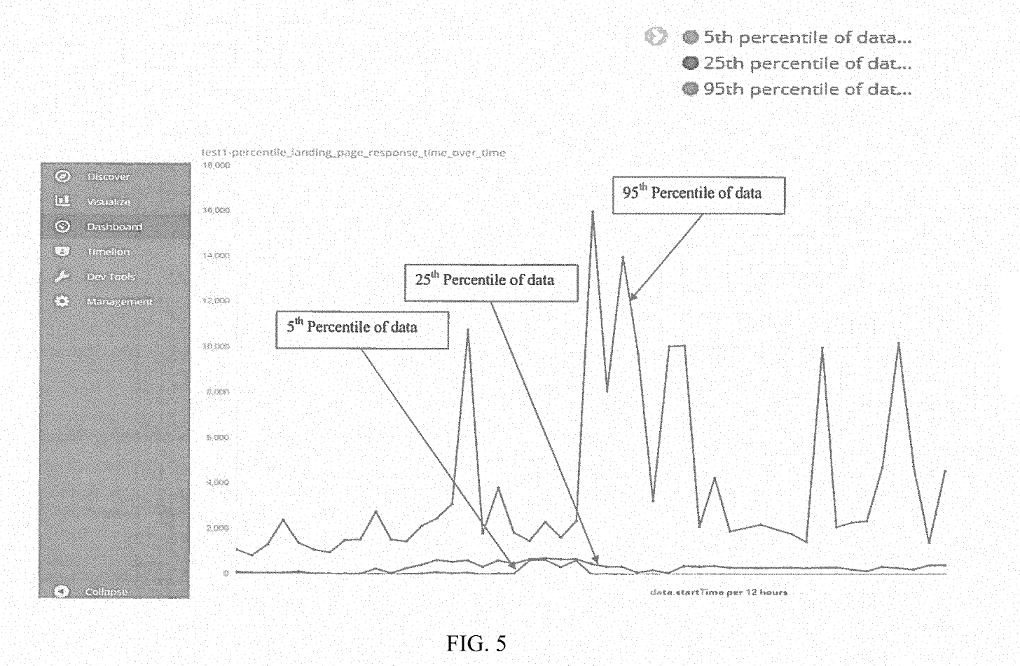

At step S414, a user interface is displayed on the PM device 202 in order to provide information that relates to the system performance problem. In an exemplary embodiment, referring to FIG. 5, the user interface may include a customizable user interface dashboard that shows several sets of historical data. In the example illustrated in FIG. 5, three sets of response time data that have been collected over a 12-hour period are shown and labeled as the 5^{th} percentile, the 25^{th} percentile, and the 95^{th} percentile for response time, respectively.

Accordingly, with this technology, an optimized process for diagnosing a system performance problem based on communication link data rates and data relating to client devices and server devices is provided. The optimized process enables a user to quickly and efficiently identify a source of a delay and/or a time at which a delay has occurred in order to identify a problem, thereby allowing the user to remedy the problem quickly and efficiently.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for diagnosing, by a performance measurement device, a system performance problem with respect to a system that includes at least one client device and at least one server device, the method comprising:
receiving, from the at least one client device, a user request that relates to a service associated with the at least one server device;
establishing a communication link betweeen the at least one client device and the at least one server device;
measuring a data rate of the communication link;
collecting first data that relates to the at least one client device;
collecting second data that relates to the at least one server device;
using the measured data rate, the collected first data, and the collected second data to determine a source of a delay with respect to the communication link; and
diagnosing, based on the determined source of the delay, the system performance problem.

2. The method of claim 1, further comprising displaying, on a display of the performance measurement device, a graphical representation of at least one from among the measured data rate, the collected first data, and the collected second data.

3. The method of claim 1, wherein the using the measured data rate, the collected first data, and the collected second data to determine the source of the delay comprises determining at least one client device performance metric and at least one server device performance metric.

4. The method of claim 3, further comprising correlating each of the at least one client device performance metric with each of the at least one server device performance metric, wherein the diagnosing the system performance problem comprises diagnosing the system performance problem based on a result of the correlating.

5. The method of claim 4, further comprising displaying, on a display of the performance measurement device, a user interface that includes information that relates to the diagnosed system performance problem.

6. The method of claim 1, further comprising using the collected first data and the collected second data to determine a time point at which the system performance problem began.

7. The method of claim 1, wherein the collected first data includes at least one from among data that relates to usage of a central processing unit of the at least one client device and data that relates to usage of a memory of the at least one client device.

8. The method of claim 1, wherein the collected second data includes at least one from among data that relates to usage of a central processing unit of the at least one server device and data that relates to usage of a memory of the at least one server device.

9. A performance measurement device configured to diagnose a system performance problem with respect to a system that includes at least one client device and at least one server device, comprising:
a display;
a communication interface;
a memory; and
a processor,
wherein the processor is configured to:
receive, from the at least one client device via the communication interface, a user request that relates to a service associated with the at least one server device;
establish a communication link betweeen the at least one client device and the at least one server device;
measure a data rate of the communication link;
collect first data that relates to the at least one client device;
collect second data that relates to the at least one server device;
use the measured data rate, the collected first data, and the collected second data to determine a source of a delay with respect to the communication link; and
diagnose, based on the determined source of the delay, the system performance problem.

10. The performance measurement device of claim 9, wherein the processor is further configured to cause the display to display a graphical representation of at least one from among the measured data rate, the collected first data, and the collected second data.

11. The performance measurement device of claim 9, wherein the processor is further configured to use the measured data rate, the collected first data, and the collected second data to determine at least one client device performance metric and at least one server device performance metric.

12. The performance measurement device of claim 11, wherein the processor is further configured to correlate each of the at least one client device performance metric with each of the at least one server device performance metric, and to diagnose the system performance problem based on a result of the correlation.

13. The performance measurement device of claim 12, wherein the processor is further configured to cause the display to display a user interface that includes information that relates to the diagnosed system performance problem.

14. The performance measurement device of claim 9, wherein the processor is further configured to use the collected first data and the collected second data to determine a time point at which the system performance problem began.

15. The performance measurement device of claim 9, wherein the collected first data includes at least one from among data that relates to usage of a central processing unit of the at least one client device and data that relates to usage of a memory of the at least one client device.

16. The performance measurement device of claim 9, wherein the collected second data includes at least one from among data that relates to usage of a central processing unit of the at least one server device and data that relates to usage of a memory of the at least one server device.

17. A non-transitory computer readable medium configured to store instructions for implementing a method for diagnosing, by a performance measurement device, a system performance problem with respect to a system that includes at least one client device and at least one server device, wherein when executed, the instuctions cause a computer to:
receive, from the at least one client device, a user request that relates to a service associated with the at least one server device;
establish a communication link betweeen the at least one client device and the at least one server device;
measure a data rate of the communication link;
collect first data that relates to the at least one client device;
collect second data that relates to the at least one server device;
use the measured data rate, the collected first data, and the collected second data to determine a source of a delay with respect to the communication link; and
diagnose, based on the determined source of the delay, the system performance problem.

18. The computer readable medium of claim 17, wherein the instructions further cause the computer to use the measured data rate, the collected first data, and the collected second data to determine at least one client device performance metric and at least one server device performance metric, to correlate each of the at least one client device performance metric with each of the at least one server device performance metric, and to diagnose the system performance problem based on a result of the correlation.

19. The computer readable medium of claim 18, wherein the instructions further cause the computer to display, on a display of the performance measurement device, a user interface that includes information that relates to the diagnosed system performance problem.

20. The computer readable medium of claim 17, wherein the instructions further cause the computer to use the collected first data and the collected second data to determine a time point at which the system performance problem began.
